(19) United States
(12) Patent Application Publication
(10) Pub. No.: US 2017/0191690 A1
(43) Pub. Date: Jul. 6, 2017

(54) FIELD-TESTING SYSTEM

(71) Applicant: Carrier Corporation, Jupiter, FL (US)

(72) Inventors: Eric T. Nelson, Fort Wayne, IN (US); Keith Heigl, Winamac, IN (US); Arvind Tapse, Vadgaonsheri (IN)

(21) Appl. No.: 15/389,642

(22) Filed: Dec. 23, 2016

(30) Foreign Application Priority Data
Dec. 30, 2015 (IN) 4329/DEL/2015

(51) Int. Cl. F24F 11/00; G05B 23/02

(52) U.S. Cl. CPC F24F 11/0009; G05B 23/0218; F24F 2011/0052

(57) ABSTRACT

A method and apparatus for testing an HVAC component is provided, the field-testing system includes an external device to test the HVAC component, and a field testing device includes at least one testing output to provide an input signal to the HVAC component, at least one testing input to receive an output signal from the HVAC component, and an external device interface to communicate with the external device, to control the at least one testing output in response to the external device, and to monitor the at least one testing input in response to the external device.

### CROSS REFERENCE TO RELATED APPLICATIONS

This patent application claims priority from Indian Provisional Patent Application Serial No. 4329/DEL/2015, filed Dec. 30, 2015, which is incorporated herein by reference in their entirety.

### DESCRIPTION OF RELATED ART

The subject matter disclosed herein relates to testing systems, and to a system and a method for field-testing an HVAC component.

Typically, HVAC systems can be used to maintain temperature and humidity within buildings and other environments. HVAC systems often include multiple HVAC components to provide HVAC functionality. Advantageously, HVAC systems may utilize many complex HVAC components to provide advanced functionality.

HVAC components may fail during operation and require replacement. HVAC components may often be replaced in the field without first determining if the HVAC component is actually faulty. A system and method that can provide field-testing of HVAC components is desired.

### BRIEF SUMMARY

According to an embodiment, a field-testing system for testing an HVAC component is provided, the field-testing system includes an external device to test the HVAC component, and a field testing device includes at least one testing output to provide an input signal to the HVAC component, at least one testing input to receive an output signal from the HVAC component, and an external device interface to communicate with the external device, to control the at least one testing output in response to the external device, and to monitor the at least one testing input in response to the external device.

In addition to one or more of the features described above, or as an alternative, further embodiments could include a modular wiring harness to connect the at least one testing input to the HVAC component and the at least one testing output to the HVAC component.

In addition to one or more of the features described above, or as an alternative, further embodiments could include that the HVAC component includes a chiller component, a fan coil component, a heat pump component, and a furnace component.

In addition to one or more of the features described above, or as an alternative, further embodiments could include that the field-testing device is battery powered or externally powered.

In addition to one or more of the features described above, or as an alternative, further embodiments could include that the external device includes a processor to execute at least one test routine via the at least one testing input and the at least one testing output.

In addition to one or more of the features described above, or as an alternative, further embodiments could include that the external device includes a sensor to identify the HVAC component.

In addition to one or more of the features described above, or as an alternative, further embodiments could include that the sensor is an optical sensor to visually identify the HVAC component.

In addition to one or more of the features described above, or as an alternative, further embodiments could include that the external device includes a communication interface to transmit at least one test information record to a central location.

According to an embodiment, a method for testing an HVAC component includes communicating with an external device via an external device interface, controlling at least one testing output via the external device interface in response to the external device, providing at least one input signal to the HVAC component via the at least one testing output, monitoring at least one testing input via the external device interface in response to the external device, and monitoring at least one output signal from the HVAC component via the at least one testing input.

In addition to one or more of the features described above, or as an alternative, further embodiments could include identifying the HVAC component via the external device.

In addition to one or more of the features described above, or as an alternative, further embodiments could include visually identifying the HVAC component via an optical sensor of the external device.

In addition to one or more of the features described above, or as an alternative, further embodiments could include selecting a modular wiring harness to connect the at least one testing input and the at least one testing output to the HVAC component, wherein the modular wiring harness corresponds to the HVAC component.

In addition to one or more of the features described above, or as an alternative, further embodiments could include executing at least one test routine corresponding to the HVAC component via a processor of the external device.

In addition to one or more of the features described above, or as an alternative, further embodiments could include selectively executing the at least one test routine manually via the processor of the external device.

In addition to one or more of the features described above, or as an alternative, further embodiments could include transmitting at least one test information record corresponding to the HVAC component to a central location via a communication interface of the external device.

Technical function of the embodiments described above includes a field testing device includes at least one testing output to provide an input signal to the HVAC component, at least one testing input to receive an output signal from the HVAC component, and an external device interface to communicate with the external device, to control the at least one testing output in response to the external device, and to monitor the at least one testing input in response to the external device.

Other aspects, features, and techniques of the embodiments will become more apparent from the following description taken in conjunction with the drawings.

### BRIEF DESCRIPTION OF THE SEVERAL VIEWS OF THE DRAWINGS

The subject matter is particularly pointed out and distinctly claimed in the claims at the conclusion of the specification. The foregoing and other features, and advantages of the embodiments are apparent from the following detailed description taken in conjunction with the accompanying drawings in which like elements are numbered alike in the several FIGURES:

FIG. 1 illustrates a schematic view of a field-testing system; and

FIG. 2 is a flow diagram of a method of field-testing an HVAC component.

### DETAILED DESCRIPTION

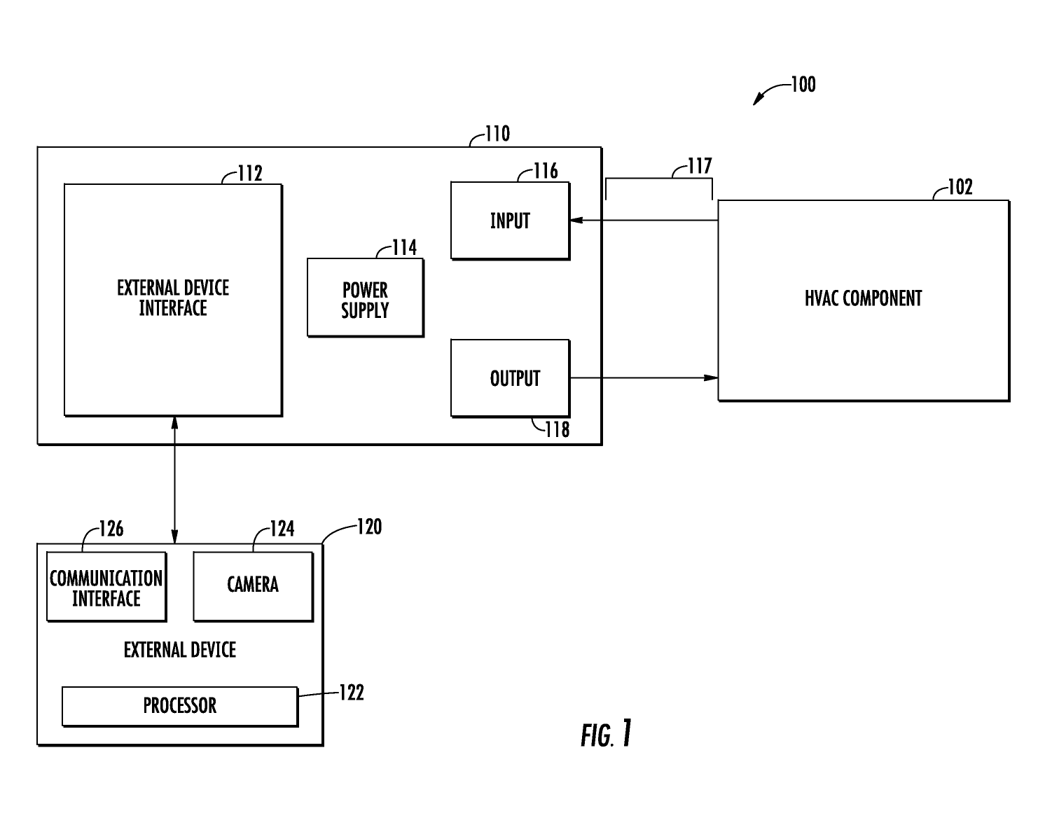

Referring now to the drawings, FIG. 1 shows a field-testing system 100 to test an HVAC component 102. In the illustrated embodiment, the field-testing system 100 includes a field-test device 110 and an external device 120. The field-testing system 100 can be utilized to provide testing and diagnostics of an HVAC component 102 at the location of the HVAC component 102 or any other suitable location. Advantageously, the field-testing system 100 is a portable and light weight system that can utilize an external device 120 that a technician may already carry. Further, the field-testing system 100 can allow technicians to field-test HVAC components 102 to quickly determine faults and prevent unnecessary replacements and repairs.

In the illustrated embodiment, the field-testing system 100 can be used to evaluate HVAC components 102. HVAC components 102 can include, but are not limited to commercial or residential HVAC components, fan coils, heat pumps, furnaces, control boards, etc. In certain embodiments, the HVAC component 102 to be tested can be referred to as a device under test (DUT).

In the illustrated embodiment, the field-test device 110 includes an external device interface 112, a power supply 114, at least one testing input 116, and at least one testing output 118. In one embodiment, the at least one testing input 116, and at least one testing output 118 may be the same. The field-test device 110 can be utilized as an interface or bridge between an external device 120 and the HVAC component 102 under testing. Advantageously, the field-test device 110 is a small and portable device that removes the need for a technician to carry multiple testers corresponding to multiple types of HVAC components 102 by utilizing a modular wiring harness 117.

In the illustrated embodiment, the field-test device 110 includes an external device interface 112. The external device interface 112 can connect to an external device 120. In the illustrated embodiment, the external device interface 112 can provide a wireless communication or a wired communication path to the external device 120. In certain embodiments, the external device interface 112 can utilize Wi-Fi, Bluetooth, USB, etc. to communicate with the external device 120. Further, the external device interface 112 can communicate with the external device 120 to send received signals and to receive instructions from the external device 120. In the illustrated embodiment, the external device interface 112 can receive instructions from the external device 120 to send instructions and signals to the testing output 118. Further, the external device interface 112 can receive signals from the testing input 116 to send to the external device 120. Advantageously, the external device interface 112 allows the external device 120 to interact with the testing input 116 and the testing output 118.

In the illustrated embodiment, the field-test device 110 can include a power supply 114. In certain embodiments, the power supply 114 can provide battery power to the field-test device 110. Advantageously, battery power allows the field-test device 110 to be utilized away from power sources. In certain embodiments, the power supply 114 can utilize an external power supply to power the field-test device 110. In certain embodiments, the power supply 114 can further charge an internal battery. The power supply 114 may utilize 24VAC power or any other suitable power supply.

In the illustrated embodiment, a modular wiring harness 117 can be utilized to connect the field-test device 110 to the HVAC component 102 under testing. In certain embodiments, the modular wiring harness 117 can adapt the testing inputs 116 and testing outputs 118 to the corresponding inputs and outputs of the HVAC component 102 under testing. In certain embodiments, the modular wiring harness 117 can provide suitable connections to the HVAC component 102. In the illustrated embodiment, a single modular wiring harness 117 can be utilized to connect the testing inputs 116 and the testing outputs 118 to the corresponding inputs and outputs of the HVAC component 102. In certain embodiments, the modular wiring harness 117 can use single or multiple cables to interconnect the HVAC component 102 and the field-test device 110. The field-test device 110 can be used with multiple modular wiring harnesses 117 corresponding to various types of HVAC components 102. In certain embodiments, the external device 120 can be utilized to identify and select the appropriate modular wiring harness 117.

In the illustrated embodiment, the field-test device 110 includes at least one testing input 116 and at least one testing output 118. The at least one testing output 118 can provide signals (voltage, current, serial transmissions, packet transmissions, etc.) to the HVAC component 102. Further, the at least one testing output 118 can simulate signals that HVAC component 102 would receive from other connected devices, or can provide a signal to the HVAC component 102 to initiate a test routine. The at least one testing output 118 can provide desired signals to the HVAC component 102 as indicated by the external device 120.

In the illustrated embodiment, the at least one testing input 116 can receive signals (voltage, current, serial transmissions, packet transmissions, etc.) from the HVAC component 102. In certain embodiments, the at least one testing input 116 can simulate inputs of connected devices that HVAC component 102 may be connected to, or can receive results or feedback from an initiated test routine. Further, the at least one testing input 116 can provide received signals to the external device 120.

In certain embodiments, testing outputs 118 and testing inputs 116 may be reconfigured as required. In certain embodiments, the connection of the modular wiring harness 117 may be able to determine and assign testing outputs 118 and testing inputs 116.

In the illustrated embodiment, the field-test device 110 is in communication with an external device 120. The external device 120 can include a processor 122, a camera 124, and a communication interface 126. The external device 120 can be a smart phone, a tablet, a laptop computer, or any other suitable computing device. Advantageously, a technician may already use such an external device 120 for other purposes.

In the illustrated embodiment, the external device 120 includes a camera 124. In certain embodiments, the camera 124 can be utilized to identify an HVAC component 102 to be tested. In certain embodiments, the camera 124 in conjunction with the processor 122 can use image recognition techniques to identify a specific HVAC component 102. In certain embodiments, the camera 124 can scan a barcode or a model number to identify a specific HVAC component 102. In certain embodiments, information regarding an HVAC component 102 can be manually entered by a technician to identify a specific HVAC component 102. In other embodiments, an external device may utilize alternative sensors such as RFID, etc. to identify a specific HVAC component 102.

In the illustrated embodiment, the processor 122 can perform testing operations on an HVAC component 102 attached to the field-test device 110. The processor 122 can utilize a companion application corresponding to the field-test device 110. In certain embodiments, a user can execute the corresponding companion application when the user desires to execute testing operations.

In the illustrated embodiment, the processor 122 can identify the HVAC component 102 utilizing the camera 124 as previously described. In certain embodiments, the processor 122 can be utilized to identify the modular wiring harness 117 that corresponds to a specified HVAC component 102. The processor 122 can then validate that the proper modular wiring harness 117 is selected.

In the illustrated embodiment, the processor 122 can further identify which tests or combinations of tests will be performed upon the HVAC component 102. In certain embodiments, the processor 122 can identify a specified test protocol. In certain embodiments, the processor 122 can transmit commands to the HVAC component 102 via the testing outputs 118. The processor 122 can provide specified voltages, signals, etc. to the testing outputs 118. In certain embodiments, the processor 122 can receive input signals via the testing inputs 116. The processor 122 can compare the received input signals from the HVAC component 102. In certain embodiments, the processor 122 can compare received inputs to expected outcomes. In certain embodiments, test routines, expected outcomes, etc. can be retrieved from storage or a remote location via the communication interface 126.

In certain embodiments, the processor 122 can execute tests or test routines automatically to assess an overall condition of the HVAC component 102. In other embodiments, the processor 122 can manually execute certain tests or test routines to limit testing to a certain aspect of the HVAC component 102. In certain embodiments, certain I/O functionality of the HVAC component 102 can be evaluated or certain steps of a test routine can be switched or skipped.

In certain embodiments, the processor 122 can execute tests or test routines that include, but are not limited to status checks, simulating functionality, stress tests, I/O tests, etc. In certain embodiments, the processor 122 can provide a visual indication of the testing process. For example, the processor 122 can utilize a display associated with the external device 122.

In the illustrated embodiment, the processor 122 can further prepare a test report that summarizes test results or otherwise provides a test determination. In certain embodiments, the test results can be stored locally in local storage or transmitted via the communication interface 126 to a network.

In the illustrated embodiment, the external device 120 can include a communication interface 126. The communication interface 126 can communicate via a network, peer to peer, ad hoc or any other suitable method with other devices or centralized services, such as cloud services, databases, email services, etc. In certain embodiments, the external device 120 can transmit test results to a central service or database. In certain embodiments, the external device 120 can email test results to relevant personnel. In certain embodiments, the external device 120 can access a test database or service during device testing to download or retrieve test parameters, conditions, routines, etc. In certain embodiments, test reference values can be determined.

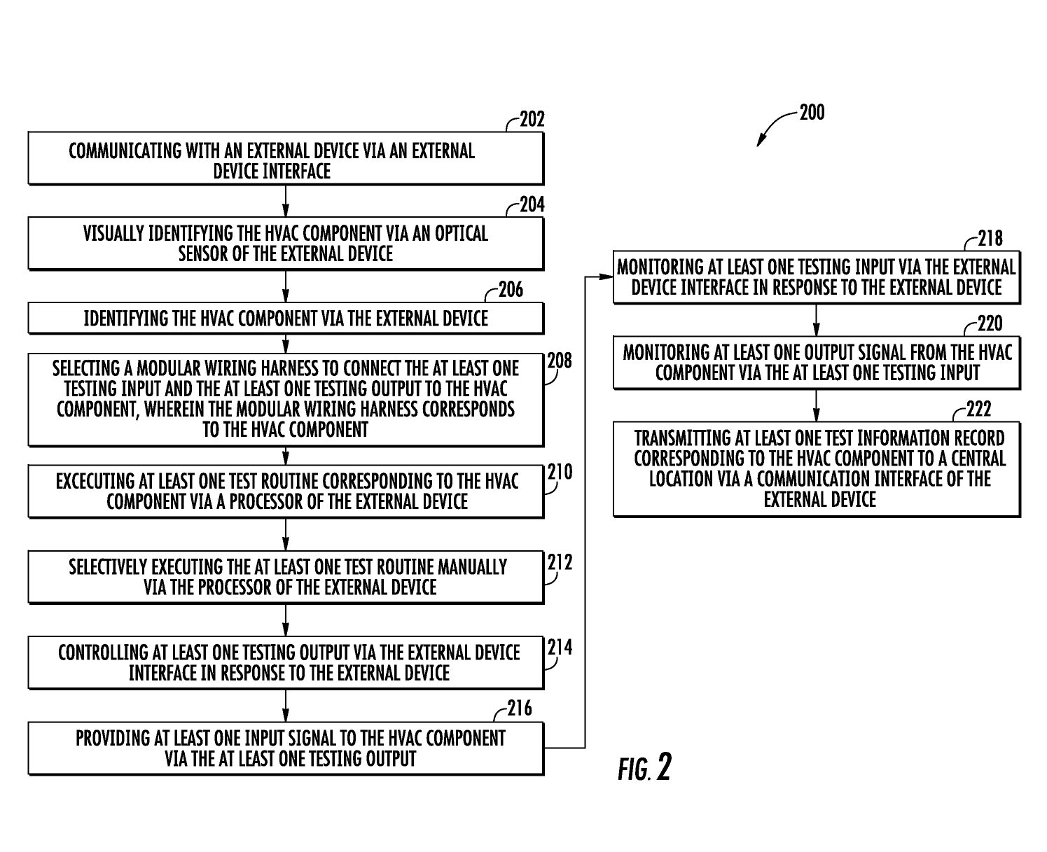

FIG. 2 illustrates a method 200 to field-test an HVAC component. In operation 202, an external device interface communicates with an external device. In the illustrated embodiment, the external device interface can provide a wireless communication or a wired communication path to the external device. In certain embodiments, the external device interface can communicate with the external device to send received signals and to receive instructions from the external device. Further, the external device can receive instructions from the external device to send instructions and signals to the testing output. In certain embodiments, the external device interface can receive signals from the testing input to send to the external device.

In operation 204, the HVAC component is visually identified via an optical sensor of the external device. In certain embodiments, the camera in conjunction with the processor can use image recognition techniques to identify a specific HVAC component. In certain embodiments, the camera can scan a barcode or a model number to identify a specific HVAC component. In operation 206, the HVAC component is identified via the external device. In certain embodiments, information regarding an HVAC component can be manually entered by a technician to identify a specific HVAC component. In other embodiments, an external device may utilize alternative sensors such as RFID, etc. to identify a specific HVAC component.

In operation 208, a modular wiring harness is selected to connect the at least one testing input and the at least one testing output to the HVAC component, wherein the modular wiring harness corresponds to the HVAC component. The modular wiring harness can adapt the testing inputs and testing outputs to the corresponding inputs and outputs of the HVAC component under testing. In certain embodiments, the modular wiring harness can provide suitable connections to the HVAC component. In the illustrated embodiment, a single modular wiring harness can be utilized to connect the testing inputs and the testing outputs to the corresponding inputs and outputs of the HVAC component.

In operation 210, at least one test routine is executed corresponding to the HVAC component via a processor of the external device. In certain embodiments, the processor can execute tests or test routines that include, but are not limited to status checks, simulating functionality, stress tests, I/O tests, etc.

In operation 212, the at least one test routine is manually selectively executed via the processor of the external device. In other embodiments, the processor can manually execute certain tests or test routines to limit testing to a certain aspect of the HVAC component. In certain embodiments, certain I/O functionality of the HVAC component can be evaluated or certain steps of a test routine.

In operation 214, at least one testing output is controlled via the external device interface in response to the external device. In operation 216, at least one input signal is provided to the HVAC component via the at least one testing output. In the illustrated embodiment, the processor can transmit commands to the HVAC component via the testing outputs. The processor can provide specified voltages, signals, etc. to the testing outputs.

In operation 218, at least one testing input is monitored via the external device interface in response to the external device. In operation 220, at least one output signal from the HVAC component is monitored via the at least one testing input. Further, the processor can receive input signals via the testing inputs. The processor can compare the received input signals from the HVAC component. In certain embodiments, the processor can compare received inputs to expected outcomes.

In operation 222, at least one test information record corresponding to the HVAC component is transmitted to a central location via a communication interface of the external device. The communication interface can communicate via a network, peer to peer, ad hoc or any other suitable method to communicate with other devices or centralized services, such as cloud services, databases, email services, etc. In certain embodiments, the external device can transmit test results to a central service or database. In certain embodiments, the external device can email relevant personnel test results.

The terminology used herein is for the purpose of describing particular embodiments only and is not intended to be limiting of the embodiments. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope and spirit of the embodiments. Additionally, while various embodiments have been described, it is to be understood that aspects may include only some of the described embodiments. Accordingly, the embodiments are not to be seen as limited by the foregoing description, but are only limited by the scope of the appended claims.

What is claimed is:

1. A field-testing system for testing an HVAC component, the field-testing system comprising:
an external device to test the HVAC component; and
a field testing device, comprising:
at least one testing output to provide an input signal to the HVAC component;
at least one testing input to receive an output signal from the HVAC component; and
an external device interface to communicate with the external device, to control the at least one testing output in response to the external device, and to monitor the at least one testing input in response to the external device.

2. The field-testing system of claim 1, further comprising a modular wiring harness to connect the at least one testing input to the HVAC component and the at least one testing output to the HVAC component.

3. The field-testing system of claim 1, wherein the HVAC component includes a chiller component, a fan coil component, a heat pump component, and a furnace component.

4. The field-testing system of claim 1, wherein the field-testing device is battery powered or externally powered.

5. The field-testing system of claim 1, wherein the external device includes a processor to execute at least one test routine via the at least one testing input and the at least one testing output.

6. The field-testing system of claim 1, wherein the external device includes a sensor to identify the HVAC component.

7. The field-testing system of claim 6, wherein the sensor is an optical sensor to visually identify the HVAC component.

8. The field-testing system of claim 1, wherein the external device includes a communication interface to transmit at least one test information record to a central location.

9. A method for testing an HVAC component, the method comprising:
communicating with an external device via an external device interface;
controlling at least one testing output via the external device interface in response to the external device;
providing at least one input signal to the HVAC component via the at least one testing output;
monitoring at least one testing input via the external device interface in response to the external device; and
monitoring at least one output signal from the HVAC component via the at least one testing input.

10. The method of claim 9, further comprising identifying the HVAC component via the external device.

11. The method of claim 10, further comprising visually identifying the HVAC component via an optical sensor of the external device.

12. The method of claim 9, further comprising selecting a modular wiring harness to connect the at least one testing input and the at least one testing output to the HVAC component, wherein the modular wiring harness corresponds to the HVAC component.

13. The method of claim 9, further comprising executing at least one test routine corresponding to the HVAC component via a processor of the external device.

14. The method of claim 13, further comprising selectively executing the at least one test routine manually via the processor of the external device.

15. The method of claim 9, further comprising transmitting at least one test information record corresponding to the HVAC component to a central location via a communication interface of the external device.
